(19) United States
(12) Patent Application Publication
(10) Pub. No.: US 2003/0090473 A1
(43) Pub. Date: May 15, 2003

(54) Multiple screen automatic programming interface

(76) Inventor: Vikas B. Joshi, Herndon, VA (US)

Correspondence Address: LACASSE & ASSOCIATES, LLC, 1725 DUKE STREET, SUITE 650, ALEXANDRIA, VA, 22314, US

(21) Appl. No.: 09/534,721

(22) Filed: Mar. 24, 2000

(51) Int. Cl. G09G 5/00

(52) U.S. Cl. 345/173

(57) ABSTRACT

A two screen programming environment uses one screen to display multiple windows of code, comments, flowcharts, and pseudo-code, and uses a second screen to display buttons representing input options for a user. The second display is a touch-entry screen which displays numerous selections grouped into sets of related functionality. The groups which are displayed as well as the elements within each group are determined according to the current state of the programming environment. Specifically, the system uses its current context to determine which input options within which groups are the most likely options to be needed by a user, and displays those options. As a user selects options and enters text, the system dynamically updates the input options displayed on the second screen. Also, to increase the number of options displayed at one time, closely-related options are displayed on some buttons so that touching different regions of such a button results in selecting different options.

### BACKGROUND OF THE INVENTION

1. Field of Invention

The present invention relates generally to the field of software development. More specifically, the present invention is related to a context-sensitive multiple screen automatic programming interface.

Portions of the disclosure of this patent document, in particular Appendix A, may contain unpublished material which may be subject to copyright protection. The copyright owner, Vikas B. Joshi, has no objection to the facsimile reproduction of the patent document or the patent disclosure by anyone, as it appears in the U.S. Patent and Trademark Office patent files or records, but otherwise reserves all rights whatsoever.

The appendix provided includes a user's manual for a product embodying the principles of the present invention. This manual provides additional discussion of the preferred embodiment of the present invention. Also, the examples used to describe and illustrate the invention contain code and comments according to the C language syntax. The principles of the present invention operate with other high-level programming languages and such operation is considered within the scope of the present invention.

2. Discussion of Known Art

Software development is a complex activity which often involves a number of software engineers, at various times, working on multiple, separate program components which ultimately must function as a cohesive application. To aid in this task, software development tools are needed which automate, simplify, and improve the software development process.

The present invention is part of a comprehensive software development environment which allows software engineers to design programs faster, to understand other engineers' code easier, and to simplify software support and maintenance. It provides a variety of context-sensitive information to a code designer or code maintainer by utilizing dual-screen displays, one of which may be a touch-entry screen.

Developments in this area have recognized the benefit of having a design environment with two display screens. The additional information which can be displayed on a second screen often assists a programmer in his task. Also, touch-entry screens, or touchscreens, are also known as programming aids which eliminate many keyboard and mouse activities. Context-sensitive menus, help-screens and typing-completion functions are also improvements used within current software development environments. The following patents describe these and other features relating to tools and systems used for software programming known at the time of filing. All element numbers used in the following patent descriptions refer to their respective disclosures.

The patent to Kaplow et al. (U.S. Pat. No. 4,202,041), assigned to Massachusetts Institute of Technology, provides for a Dynamically Variable Keyboard Terminal. A dynamically variable keyboard terminal system having a keyboard display unit using an input panel with a plurality of touch-sensitive locations thereon and a keyboard display unit in alignment therewith. The system includes means for generating and storing information concerning symbols which make up one or more working symbol sets, such symbol information being author definable in accordance with a predetermined terminal definition language. The symbol information can include a symbol configuration for display, if applicable, or a symbol action to be performed, if applicable. Means are also provided for generating and storing information concerning a plurality of keyboard images which use such symbols and which keyboard information can be used for displaying a keyboard image at the keyboard display unit. A user can selectively touch one or more such locations so as to obtain symbol information for display on the keyboard display unit or on a monitor display unit, if applicable, or for performing an action associated with such symbol, if applicable.

The patent to Maghbouleh (U.S. Pat. No. 5,513,305), assigned to Apple Computer, Inc., provides for a System And Method For Documenting And Displaying Computer Program Code comprising a token annotation unit, comment analyzer, token parsing library and a code outline unit. In addition, the reference teaches elements directed to documenting program code by defining a set of outline nodes that form a program outline. Each outline node corresponds to a block of program called code. Explanations are associated with an annotation within an outline node upon request. When an outline node is defined, the disclosed teachings create an outline node object that includes a title, a reference to a corresponding program code block, and an outline level that specifies the location node in the outline. The Maghbouleh reference fails to provide for automatic commenting in the given comment field on the same line as the code token but rather requires an annotation. In addition, the present invention does not require the underlining or need to store comments in an annotation node.

The patent to Deeran et al. (U.S. Pat. No. 5,594,471), assigned to Casco Development, Inc., provides for an Industrial Touchscreen Workstation With Programmable Interface And Method. An industrial computer workstation having a display screen and a touchscreen. The touchscreen has a display touch zone that overlaps the display and a border touch zone located outside of the display. An input interface is programmable to define portions of the display touch zone and the border touch zone as user input areas of the touchscreen. Elements of specific interest are (14) and (18) showing a touchscreen and the border touch zone that overlaps the outside of the display.

The patent to Dulaney et al. (U.S. Pat. No. 5,031,119), assigned to Tandy Corporation, provides for a Split Screen Keyboard Emulator. A system for providing keystroke data to an application program without utilizing a keyboard that simultaneously displays application program graphics and a keyboard representation on different segments of a screen. Keys are selected by touching the screen (12) at the location of the graphic representation of the key on the screen. The system is transparent to the application program.

The patent to Saich (U.S. Pat. No. 4,028,695), assigned to The Solartron Electronic Group Limited, provides for a Data Terminals Having Interactive Keyboards And Displays And Data Processing Apparatus Incorporating Such Terminals. A display is provided having a plurality of zones (64a, 68a, 66a) wherein the display is arranged to illustrate in each zone an indication on the message represented by the key corresponding to that zone. In addition, the keys are in the form of touch keys serving to manually select the specific key and cause a visual appearance of the display to change.

The patent to Brittian et al. (U.S. Pat. No. 3,882,446), assigned to Texas Instrument Incorporated, provides for an Interactive Horizon Building, Analysis And Editing includes a section for display (42) with a plurality of displays (44A, 44B, 44C and 44D) in a touch input interface (46). In addition, a alternative CRT monitor (34) produces output displays of various segments on the original display (42).

The patent to Crossland et al. (U.S. Pat. No. 4,720,781), assigned to STC PLC, provides for a Data Processing Terminal Having Support Module And Portable Display Module For Liquid Crystal Display. Of specific interest is display (2) and touch input (3) with auxiliary keyboard input (4).

The patent to Hart et al. (U.S. Pat. No. 3,534,396), assigned to General Motors Corporation, provides for a Computer-Aided Graphical Analysis. Of specific interest is the design console illustrated in FIG. 2 which includes CRT display (24), touchscreen input stylus (26) on input area (20), and auxiliary alpha-numeric input keyboard (22).

The patent to Arai et al. (U.S. Pat. No. 5,436,639), assigned to Hitachi, Ltd., provides for an Information Processing System. Of specific interest is FIG. 4 illustrating a display (102) and touch input area (101). This device, however, differs significantly from the present invention in that a complicated arrangement of monitoring devices(107, 108) are necessary in addition to devices (111, 121) to fully associate the input of device (104) with the input area (101).

The patent to Jakobs et al. (U.S. Pat. No. 5,300,943), assigned to Goldstar Electron Co., Ltd., provides for a Multiple Display Workstation With Conductive Surface Overlay Control. The system includes a workstation with multiple, functioning related displays clustered under and controlled by a common transparent overlay control device. FIG. 1 illustrates displays (6, 8) and touch input area (7).

The patent to Kaehler (U.S. Pat. No. 5,128,672),assigned to Apple Computer, Inc., provides for a Dynamic Predictive Keyboard. The reference includes a keyboard having the ability to predictively display different characters in association with various keys within a variety of predefined character set layouts, based upon either the character preceding an insertion point in a corresponding text field on a display, or the last character entered from the keyboard. All keys are updated to display a character set layout that corresponds to the set of characters from which the user would be most likely to want to select a character from next, based upon the frequency of that particular character combination being used in either a particular language or application. Of additional interest is that the keyboard can be implemented to operate as either a touch-sensitive display or as a collection of interactive images on any number of different displays.

The patent to Sasaki (U.S. Pat. No. 5,717,425), assigned to Ricoh Company, Ltd., provides for an Input Apparatus And Method Having Improved Operation Behavior For Input. A display changing unit changes, in a predetermined sequence, displaying of a group of items from among a plurality of groups of items. The item to be input is then selected from the corresponding group of items of the plurality of groups of items through an item selecting unit.

The patent to Tkacs et al. (U.S. Pat. No. 5,526,268), assigned to Westinghouse Electric Corporation, provides for a Dynamic Language Changing Process Graphics. The device includes a control input such as a pointing or touch-sensitive screen which triggers the process to change from one set of definitions to another. Devices particularly applicable to changing between languages, that also can change graphics and similar elements of symbology, for example so that a troubleshooter speaks only one language or a person familiar with one type of graphic display or set of units of measurement can quickly comprehend the status of a monitoring and control system that normally uses a different language or display.

The patent to Saito et al. (U.S. Pat. No. 4,956,773), assigned to Hitachi, Ltd., provides for a System And Method Of Generating A Source Program From Inputted Schematic Information. Schematic information items of a module structure diagram, processing flow diagram, internal data definition diagram or an interface data definition diagram are read out from memory for each module and have stereotype sentences and symbols added thereto, to generate the individual sentences of a source program.

The patent to LeBlang et al. (U.S. Pat. No. 4,809,170), assigned to Apollo Computer, Inc., provides for a Computer Device. A support system for a CASE application provides a configuration management and features such as transparent retrieval of named versions of program sequences on a line by line basis as well as task monitoring and reporting. Task monitoring provides notification and monitoring of tasks being accomplished as well as “blueprints” to follow in the future for the accomplishment of the same or similar tasks.

The patent to Aschar (U.S. Pat. No. 5,379,388), assigned to Advanced Micro Devices, Inc., provides for Digital Signal Processing Apparatus With Sequencer Designating Program Routines. A digital signal processing apparatus which employs a ROM-stored library of predetermined instructions which are user-accessible via a sequencer for execution as a program of instructions. The apparatus preferably may also include an instruction RAM which is user-programmable to supplement the prestored instructions in the on-board instruction ROM.

The patent to Brown et al. (U.S. Pat. No. 4,179,748), assigned to National Semiconductor Corporation, provides for a Programmer And Method Of Storing Information Therein And Accessing Information Therefrom. A programmer unit which is connected to a keyboard of a machine is capable of storing, as a program, the sequential occurrence of key closures, and of supplying simulated key closures through the keyboard to the machine in the order in which such key closures were initially generated and stored.

The patent to Masui et al. (U.S. Pat. No. 4,455,619), assigned to Hitachi, Ltd., provides for an Interactive Equipment For Computer Programming By Linkage Of Labeled Block Representations Of Arithmetic/Logical Subprograms. A programming equipment is used for automatically constructing programs by selecting and interconnecting a plurality of previously prepared unit programs in accordance with instructions by an operator. A screen of a display unit is divided into a plurality of partial display areas. A memory has a plurality of unit storage areas, one for each partial display area, for storing unit program names and data flow specifications. The information of the respective area is displayed in block form on the display unit so that the operator can readily construct a process data flow by operating the input device while watching the display unit. The programming equipment reads out the area information from the areas in a predetermined sequence, and selects and interconnects the unit programs to construct the program corresponding to the process data flow.

The patent to Walz et al. (U.S. Pat. No. 4,510,583), assigned to Gruman Aerospace Corporation, provides for a Keyboard Terminal. A keyboard terminal for entering test programs written in an English-format computer programming language into computerized automatic test systems is disclosed. In response to the activation of selected user-activated keys associated with a programmable keyboard, a pre-programmed microprocessor control system generates word character strings corresponding to the words of a predetermined test programming language, thereby allowing single keystroke entry of test program words into a control computer associated with the automatic test system.

The patent to Cardell, Jr. et al. (U.S. Pat. No. 3,753,233), assigned to The Bunker-Ramo Corporation, provides for a Method And Apparatus For Data Entry includes a format guidance mask which automatically incorporates alternative fields or words for the most often required information in the data entry section requested. Alternative words are displayed in groups on the same line and are normally arranged from left to right according to their descending frequency of use.

The patent to Auer et al. (U.S. Pat. No. 4,725,694), assigned to American Telephone and Telegraph Company and AT&T Bell Laboratories, provides for a Computer Interface Device. A computer terminal device includes a flat screen display element and a touch-sensitive element. Simulated keyboards can be displayed on the display element and, in response to the touching of the simulated keys, generate appropriate control signals. The same flat screen display can also be used to display computer output, either the result of calculations or the result of information retrieval requests.

The patent to Hansen (U.S. Pat. No. 5,442,456), assigned to U S WEST Advanced Technologies, Inc., provides for a Method And Apparatus For Multi-Level Navigable Video Environment. An apparatus for generation of multi-level navigable video environments is disclosed. Generation of the virtual realities is accomplished by a video monitor, a touch screen, a CPU, and a compact disc storage device. The storage device contains pre-generated audio and visual data. The visual data includes a plurality of digitized photographic images stored as a plurality of frames of a visual track. The frames may be selectively accessed by a user through the touch screen to provide the user the ability to navigate through a navigable video environment. Further, while the user is within the navigable video environment, a second-level of a navigable video environment is accessible. The data for generation of the second-level of video environment is also stored within the storage device and is also pre-generated.

The patent to Garloffet al. (U.S. Pat. No. 5,699,310),assigned to Dynasty Technologies,Inc., provides for a Method And Apparatus For A Fully Inherited Object-Oriented Computer System For Generating Source Code From User-Entered Specifications. A computer system wherein object-oriented management techniques are used with a new means for generating code to provide for the automatic generation of source code. The invention includes three executable components: an inheritance engine that provides a detailed fully inherited view of individual objects; an Operator Interface that allows a software Developer to provide a program specification; and a generator for generating source code for a computer system. The inheritance engine obtains objects from Design Knowledge Bases, Specification Knowledge Bases and Generation Knowledge Bases for the Generator. The Generator then operates on the objects to produce source code.

The patent to Ishida (U.S. Pat. No. 5,684,969), assigned to Fuji Xerox, provides for an Information Management System Facilitating User Access To Information Content Through Display Of Scales Information Nodes. A user can easily grasp the relationship between the whole information and the detailed information in a single display area while continuously zooming in and out of the nodes and easily grasp significance of the data.

The patent to Matheny et al. (U.S. Pat. No. 4,884,068) provides for a Multiple Display System. In the described system a single light-pen, or other input device, is used to select items from a plurality of monitors. The detecting means, therefore, detects which monitor, as well as which region of the monitor, is selected.

Whatever the precise merits, features and advantages of the above cited references, none of them achieve or fulfill the purposes of the present invention. The above software development aids do not provide for an integrated dual-screen development environment which utilizes a touch-entry or selectable button entry screen to display multiple groupings of input options wherein the groupings displayed as well as the displayed elements within each grouping dynamically change to reflect those input options which are most likely to be needed by a user, considering the current context of the environment.

### SUMMARY OF THE INVENTION

The present invention details a software development environment for entering and editing programming code, comments and pseudo-code. A two screen programming environment uses one screen to display multiple windows containing code, comments, flowcharts, and pseudo-code, and uses a second screen to display buttons representing input options for a user. The second display is a touch-entry screen, mouse-assisted screen, or equivalent selectable display entry device which displays numerous selections grouped into sets of related functionality. The groups which are displayed as well as the elements within each group are determined according to the current state of the programming environment and the programming language chosen. Specifically,the system uses its current context to determine which input options within which groups are the most likely options to be needed by a user, and displays those options. As a user selects options and enters text, the system dynamically updates the input options displayed on the second screen. Also, to increase the number of options displayed at one time, closely-related options are displayed on one or more buttons so that touching different regions of such a button results in selecting different options.

### BRIEF DESCRIPTION OF THE DRAWINGS

FIG. 1 illustrates a dual display computer system according to the present invention.

FIG. 2a and 2b, collectively, illustrate a detailed view of sample information for each display within the computer system of the present invention.

FIG. 3 illustrates a flowchart depicting the logical flow of the present invention.

FIG. 4 illustrates the initial information display screen of the present invention.

FIG. 5 illustrates the initial touch screen of the present invention.

FIG. 6 illustrates the touch screen after the cursor has moved down one line.

FIG. 7 illustrates the touch screen after the cursor has moved down to another line.

FIG. 8 illustrates the touch screen after the touchkey “break” has been touched.

FIG. 9 illustrates the touch screen after the touchkey “*” has been touched.

FIG. 10 illustrates the touch screen after the touchkey “( )” has been touched.

FIG. 11 illustrates the touch screen after the touchkey “new_an_p→” has been touched in its left part.

FIG. 12 illustrates the touch screen after the touchkey “new_an_p→” has been touched in its right part.

FIG. 13 illustrates the touch screen after using Mem0 and Mem1 in the present invention.

FIG. 14 illustrates the information display screen after touching an “if” touch key in the present invention

FIG. 15 illustrates the touch screen illustrating new possible phrase entries for the “if” statement presented from the action of FIG. 14.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as a exemplification of the principles of the invention and the associated functional specifications of the materials for its construction and is not intended to limit the invention to the embodiment illustrated. Throughout the specification and drawings, references to specific code are for illustration purposes only. Those skilled in the art will envision many other possible variations within the scope of the present invention.

The present invention employs a touch screen as the primary input device. A programmer enters pseudo-code, or programs by simply touching various touch screen buttons representing program tokens, identifiers, reserved words, operators, and comment phrases. The buttons on the touchscreen also allow a programmer the ability to move about in a file and perform simple as well as complex editing commands. Some of the advantages of utilizing a touchscreen include avoiding memorization of hot-key sequences, preventing typographical or spelling errors when entering tokens, and reducing mouse and keyboard interactions. The present invention also uses a dual screen display. Traditional environments use a single screen for two functions that compete for screen area: display of information (e.g. file contents) and display of commands (e.g. tool-bars, pull-down menus, pop-up menus). In addition to obscuring information displays, menus typically provide a limited number of options and are nested in hard-to-remember, hierarchical arrangements. In contrast, the present invention employs two display screens—the Information Display Screen (IDS) and the Touch Screen (TS).

The Touchscreen (TS) has already been introduced as the primary input device for a user; the traditional keyboard remains available but simply becomes the secondary input means. The touchscreen's primary function is to display touchkeys which represent a large set of edit operations, probable tokens which will be used in a program being edited, and probable words and phrases which will be used in comments. The touchkeys displayed on the TS are analogous to keys on a keyboard, they are activated by being touched with a finger, stylus, or actuated by mouse input. When touched, each touchkey performs an action such as inserting a word or phrase at a current cursor position or performing an edit operation. The function of a touchkey is indicated by a label on the touchkey. For example, the touchkey with the label “DelLine” is used for deleting a line from a file being edited.

The primary function of the IDS is to display information. Depending on the context of the environment, the information on the IDS will display one, or a combination, of the following: file(s) being edited, a flowchart of a program or pseudo-code, and information about a currently open project.

Throughout the remainder of this specification the following terms and associated definitions will be used:

Touchboard: The whole display image on the TS is called a touchboard; it contains a collection of touchkeys. The touchboard also contains a touch-viewport which is an window, or aperture, of a portion of the image displayed on the IDS. The touch-viewport (or touchport) provides to a user the ability to navigate a program and move the cursor by touching a part of the image that is displayed.

Touchkey: a button displayed on the TS.

Applique: A touchboard consists of many sections of touchkeys. Each such section contains a set of related keys and is called an applique. Depending on which operations a user wants to perform, different appliques are available for display. A touchkey which causes an applique to be brought into a touchboard or causes the whole touchboard to be replaced by a different touchboard is called a trans-touchkey.

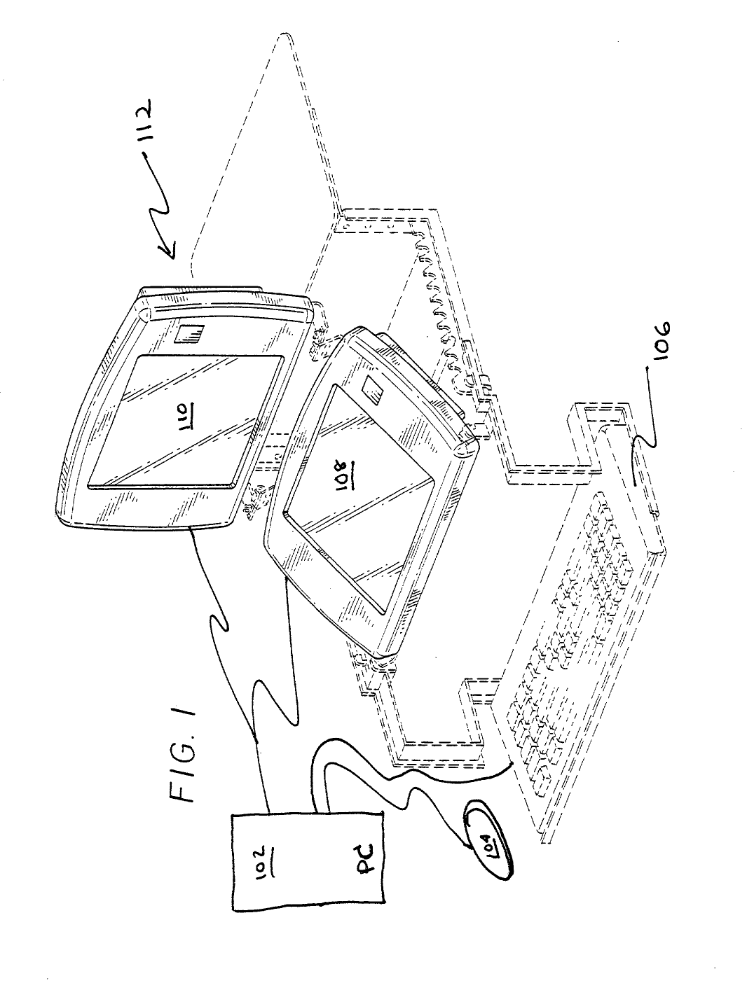

FIG. 1 illustrates the basic architecture of a system embodying the present invention. A traditional computer system 102, 104, and 106 is connected to dual displays 108 and 110. While this figure illustrates the dual displays as a single unit 112, other configurations of dual displays, including, for example, integrated dual displays, are considered within the scope of the present invention.

Display 108 is a touchscreen and detects the position and pressure of either a user's finger or stylus implement. A touchboard with various buttons, boxes and input areas is displayed on display 108 and the user's input is detected in relation to the touchboard's elements to accomplish a particular task. Pressure touchscreens can be replaced by infrared, acoustic or equivalents without departing from the scope of the present invention.

Display 110 is a graphical display screen and typically displays output or information to the user. As previously stated, both conventional computer displays (not shown) as well as an integrated display 110 are contemplated within the scope of the present invention. A preferred embodiment combines displays 108 and 110 into single unit 112 with display 110 being positioned above display 108. This arrangement allows a user to easily see both screens with only minor body or eye movements.

A preferred embodiment of the present invention is described with respect to a single touchboard out of a choice of many available touchboards. This description reduces the sheer volume of variables and alternatives presented by this invention while still ensuring a clear and complete explanation of its inventive features.

The present invention includes touchboards for manipulating files, editing programs and pseudo-code, searching and replacing text, locating text, manipulating blocks of text, displaying flowcharts, printing files, and performing ancillary functions. Pointing devices such as mouse, stylus or other known input devices may be used to select displayed touch screen inputs without departing from the scope of the present invention. As indicated above, the present invention will be discussed in relation to one of these touchboards—the touchboard for editing a source file is the exemplary touchboard.

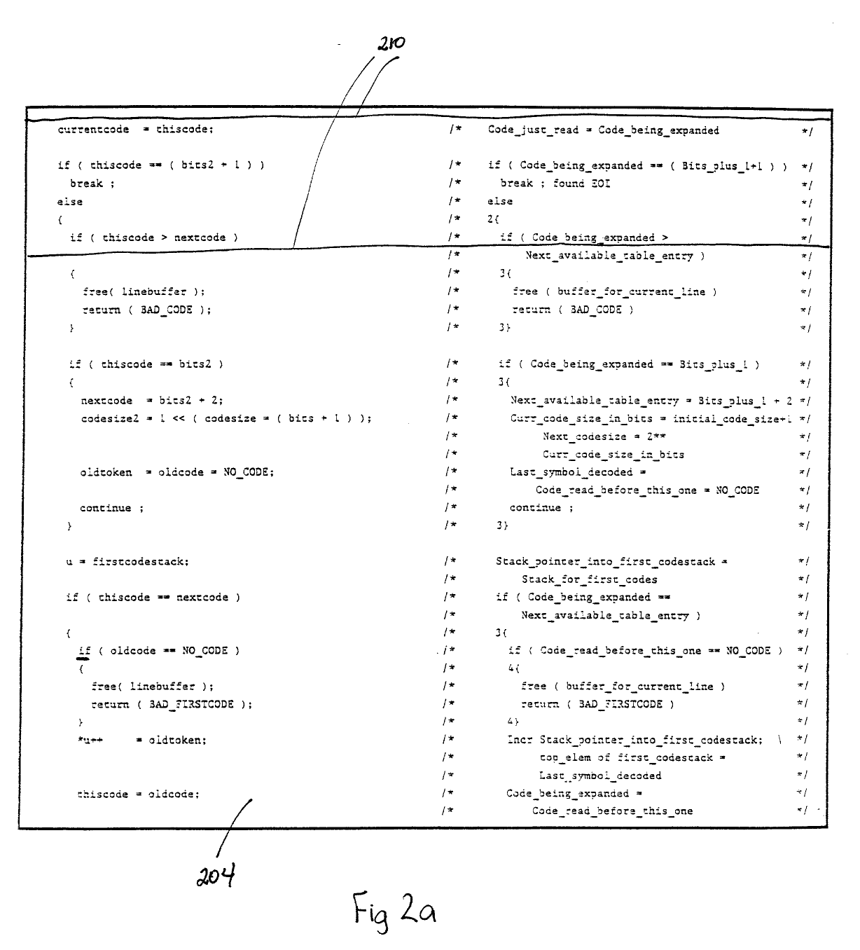

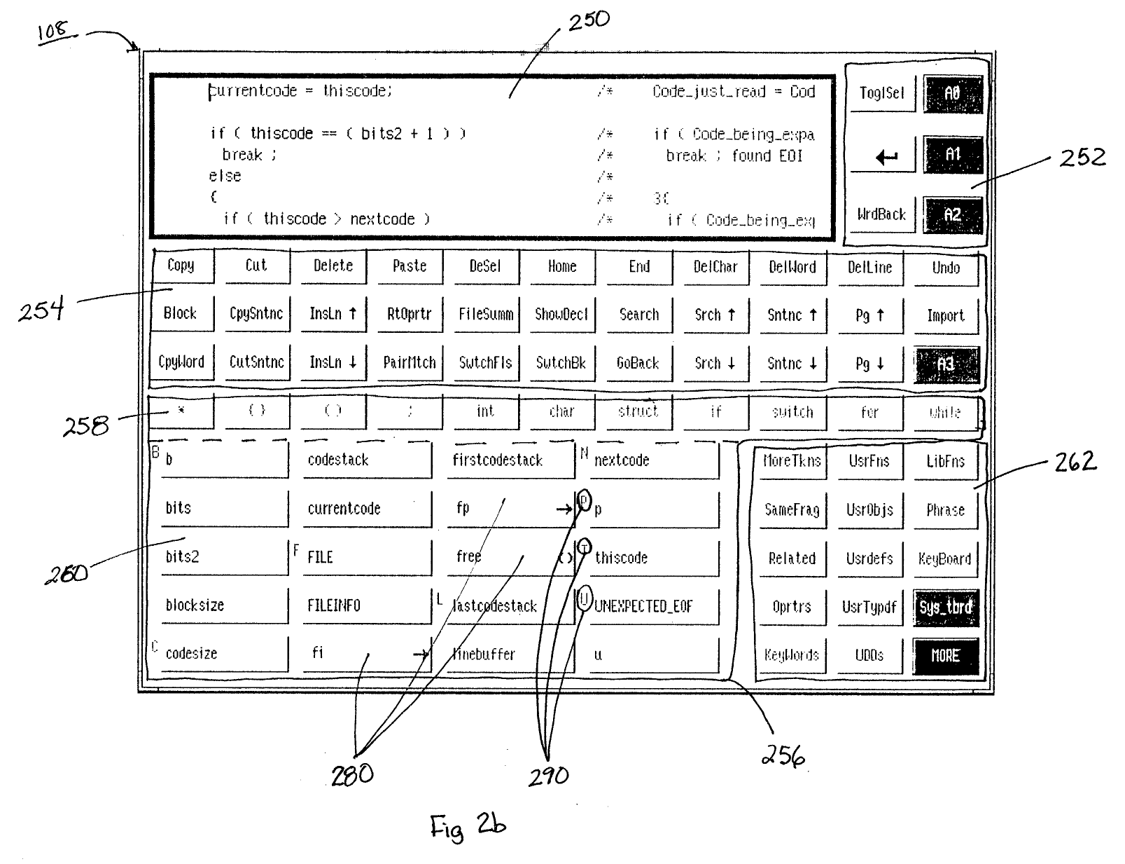

FIGS. 2a and 2b illustrate unit 112 in greater detail. Display 110, which is hereinafter referred to as the Information Display Screen (IDS), is depicted in FIG. 2a. Display 108, which is hereinafter referred to as the Touchscreen (TS), is depicted in FIG. 2b.

As previously discussed, within the context of the entire software development system of which the present invention is a part, IDS 110 typically displays multiple windows relating to 1) a file or files being edited, 2) flowcharts of comments, code or pseudo-code, and 3) status information about a current project file. In particular to FIG. 2a, a single window 204 of code and comments is depicted.

Touchscreen 108 includes a number of different regions. Touchport 250 is a viewport to IDS 110; it displays a portion of the IDS display image 204. On IDS 204, two track bars 210 are used to indicate the part of the file which is currently displayed within touchport 250. The remaining regions of touchscreen 108 are made up of a number of touch keys which allow a user to enter editing commands, keywords, tokens, operators and other commands within the programming environment. The layout depicted in FIG. 2b is an example layout which compartmentalizes related keys into separate regions of the screen and depicts an example screen shot of TS 108 at a single instance in time. The screen contents and layout change as the user enters different information and selects various commands. In a preferred embodiment, TS 108 consists of 5 separate groupings, or appliques, of touchkeys. Alternative placements, arrangements and groupings are considered within the scope of the present invention.

Touchport 250 displays a few lines of code in the vicinity of the current cursor position within the file displayed on IDS 204. A user touches and drags within touchport 250 to reposition the cursor, select a small block of text, or scroll through the file. In order to make it easier to touch a location within touchport 250, in a preferred embodiment, the font-size within touchport 250 is larger than the font employed in IDS 204. The present invention allows a user to select and vary these font sizes. The applique 252 to the right of touchport 250 has 6 touchkeys some of which allow a user to bring different appliques into the currently displayed touchboard.

Below touchport 250 is an array of touchkeys 254. These keys, in a preferred embodiment, occupy three rows and provide those operations most commonly used during editing. Example operations include, but are not limited to, InsertLine, DeleteLine, Copy, Cut, Paste, Undo, PgUp, PgDown, etc. In a preferred embodiment, over 30 operational keys are displayed in this region. The availability of these keys alleviates a programmer's need to memorize hot-key sequences or remember the arrangement of menu items. Also included in this region are touchkeys to allow a user to switch between open files and tile or arrange windows displayed within IDS 204. Below region 254 is a two-part region 256 which displays the most probable tokens for selection. These touchkeys display the tokens the user is most likely to insert at the given cursor location. Touching these keys will enter such tokens as keywords, identifiers, and operators into the source code file. The first part 258 of region 256 displays an operators and keywords applique. This applique 258 is one row of touchkeys which provide frequently used operators and keywords in a context-sensitive manner. Examples include *, { }, ( ), ;, int, char, for, etc. The second part 260 of region 256 displays probable identifiers. This applique 260 is a multi-key array which provides identifiers in a context-sensitive manner. Identifiers include, but are not limited to, function names, names of objects and variables, and #defined constants. The default behavior of one embodiment only considers identifiers within the current file when predicting likely identifiers. However, other touchkeys are available to affect this behavior. Options include expanding the list of files to include header files, #inc files, explicitly selected files, and all files in a current project. Furthermore filters are available to refine the selection of identifiers; user selectable options include specifying that the only identifiers displayed are one, or combination, of user functions, user objects, library functions, library objects, user defined constants, library defined constants, user TYPE definitions, library TYPE definitions, user defined macros, or library defined macros.

The final applique in this example embodiment is region 262 which displays touchkeys that provide options to affect the appliques currently being displayed. As examples, buttons are present which allow a user to replace applique 260 with an expanded list of probable operators, display more identifiers, or to display an expanded list of editing and movement commands.

In typical operation of the present invention, a user opens a project by utilizing appropriate touchkeys on TS 108. Opening a project entails locating and importing source code files, library routines, and header files into the software development environment. Preferably, the files are stored as plain ASCII files and specially coded files. The present invention also contemplates other current and future file formats within its scope. Once a project's files are imported into the present invention's environment, a user edits the files and then saves them to non-volatile memory. A preferred embodiment of the present invention does not integrate other tools such as debuggers and compilers into the editing environment; however, this modification is within the skill of a knowledgeable artisan and considered to be within the scope of the present invention. While the present invention allows multiple windows to be open, in the exemplified embodiment, at any instant, there is a single window which has the focus of the user and this window will be hereinafter referred to as the foreground window or active window.

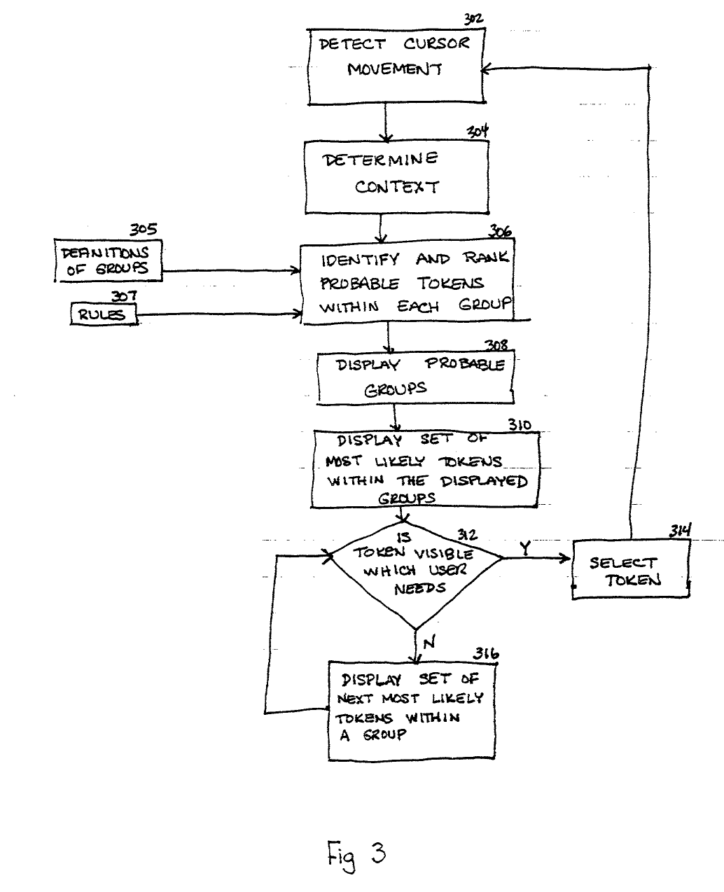

FIG. 3 depicts a flowchart of the logic of one aspect of the present invention. During editing of a file in the active window, inputs by the user result in moving the cursor within the file; this movement is detected 302 by the system. Typing in a declaration, entering a navigation command, and selecting one of the many available touchkeys on TS 108 all may result in movement of the cursor. At each detected cursor movement, the system, in step 304, evaluates the current context of the environment. The context of the environment comprises many different factors; some of these factors include the rules of syntax as per the grammar of the language, the semantic rules of the language, some heuristic rules based on how a real-life programmer enters the program and various patterns that are observed in the programming pattern of the person who is using the system, the current cursor position in the current file, the type and sequence of program sentences that are present in the local vicinity of the cursor, the type and sequence of program sentences that are present in a larger vicinity of the cursor.

From the context detected in step 304, the system of the present invention predicts, in step 306, the most likely tokens a user will need to complete their current activity. The present invention does not require a specific prediction algorithm or method. Historically, the analysis of computer software has identified various rules that describe the relative likelihood of some operations occurring within close proximity to other operations. A short list of some example rules which help predict the most-likely-to-be-needed tokens include:

1. When the user is likely to enter a declaration, the most-likely-to-be-needed tokens are declaration-specifier keywords, user-defined declaration-specifiers. After the declaration-specifiers have been entered, any variables that have been used by the user elsewhere in the program but have not yet been declared in the current context are the most-likely-to-be-needed.

2. After identifiers, an operator is a more likely candidate to be needed than another identifier.

3. Many of the keywords are not followed by other keywords.

4. An identifier that has been used in conjunction with another identifier in some part of the program is likely to be used in conjunction with the same identifier in other parts of the program.

5. An identifier that has been used in conjunction with an other identifier in some part of the program is likely to be used in conjunction with the identifiers that have been declared in the vicinity of the declaration of that other identifier.

6. Identifiers that have similarities in their spelling are likely to be used in conjunction with each other.

7. The identifiers that have been recently entered by the user are likely to be entered again.

8. Identifiers that have been used in conjunction with certain operators in some part of the program are likely to be used again in conjunction with those operators in other parts of the program.

As stated previously, the present invention contemplates a variety of rules 307 and methods recognized in the art for predicting probable tokens based on the current context of the environment. Of particular importance to the present invention, the system separates the list of probable tokens into a plurality of sets and then ranks the elements within each set by likelihood of use. In a preferred embodiment, the sets are grouped according to the function of their element tokens and include 1) identifiers, 2) keywords, 3) operators, 4) edit commands, 5) delimiters, 6) comment phrases, 7) navigation commands 8) file manipulation commands, 9) text searching and selecting commands, 10) flowcharts, and 11) tokens which effect the display of the touchscreen 108. Other groupings of tokens are contemplated within the scope of the present invention; the specific definitions 305 of which group a token belongs to are provided to step 306 which then ranks the probable tokens within each group. Based on the current context of the environment, the system displays, in steps 308 and 310 respectively, the most probable groups and the most likely needed tokens within those groups. As no predictive logic is entirely perfect, the needed token may or may not have been selected and displayed. In step 312, the user determines if the token they need is displayed; if it is not displayed, then the user selects an appropriate touchkey to display more operators, keywords, or identifiers. This next set of predicted elements for a group are the next-most-likely tokens within the selected grouping; after these next tokens are displayed, step 312 is repeated. In a preferred embodiment, if the user needs a particular identifier which is not properly predicted, then the user affects the next set of identifiers displayed by typing in the first, or first few, letters of the required identifier.

If the token which the user needs is displayed on touchscreen 108, then the user selects, in step 314, that token which then gets inserted at the current cursor position and the process returns to step 302.

Referring back to FIG. 2b, a number of features are illustrated which up until now have not been fully discussed. Three buttons 280 are different than the other touchkeys display on TS 108. These three buttons have labels on both their left and right sides. The present invention also contemplates within its scope other label arrangements such as a middle label, and upper and lower labels. These additional labels turn a single button into a multifunctional touchkey. When a user selects touchkeys 280 the resulting action depends on which area or region of the touchkey was selected. For example, selecting the left-side of the touchkey with token “fp” will result in “fp” being inserted at the current cursor position. However, selecting this touchkey on its right-side will result in “fp->” being inserted at the current cursor position. One use of multifunction touchkeys of this type is to increase the options for those types of identifiers which typically are followed by specific operators. Examples of three such identifiers include:

1) function names are mostly followed by a pair of parentheses which enclose an argument list;

2) pointers to instances of structure-types are often followed by “->”, and

3) instances of structure types are followed by “.”.

In a preferred embodiment, the most-probable tokens in applique 260 are arranged in alphabetical order. To assist a user with quickly locating identifiers, letters 290 are provided in-between the touchkeys to denote the first touchkey which has a label starting with a particular letter. The present invention, however, includes a selectable option which displays the tokens in order of likelihood rather than alphabetical order. When this option is selected, no letters 290 are displayed within applique 260.

Other features which make the present invention appealing to the programmer include, but are not limited to:

automatic formatting

learning capability for auto formatting

syntaxual error tolerance

color highlighting

adjunctive associations

associating comments for multiple lines of code.

In automatic formatting, the program of the present invention automatically formats the code and comments, therefore not requiring the user to place the code/comments at a specific location on the programming screen. Also, the system will learn and adapt to the user's formatting style as the work product progresses. A touch key LN-IF(learn initial format) when pressed will adapt to the user's style. A touch key AU-IF (automatic initializer format) represents a system default format.

The present invention includes the rules of syntax for the programming language of interest. As such, the system allows some errors in syntax during the code/comment creation phases. The rules of syntax have been incorporated within the prediction stages of TS key generation. If, however, the rules are not entirely followed by the entry of information, the system will determine that a violation has occurred and assume the correct rules of syntax.

To assist the developer, the displayed sections of code and comments are color key coded. A cursor selection of a line of code will also correspondingly color highlight the appropriate associated comments and vice-versa to enable quick review by the user.

The system provides for adjunctive associations. The following example illustrates this feature.

| | |
|---|---|
| int idx; | /*<index “ALT”:max index*/ |
| | /* “ABR”:max_idx>*/ |

In this example the use of “alt” or “abr” allows the programmer to enter alternative or abbreviated forms of the comment for the variable “idx”.

The system includes associating different levels of detail with comments. For example, using the touch key “WHOL”. The comment following the use of this term is an overall comment for the code in the remaining part of the C language constructs, such as, a “compound statement”, “while loop”, “for loop”, “if statement”, etc. Following the term “HI VW”, the comment gives an overall comment for the code below whose comments contain the term “HIDE”.

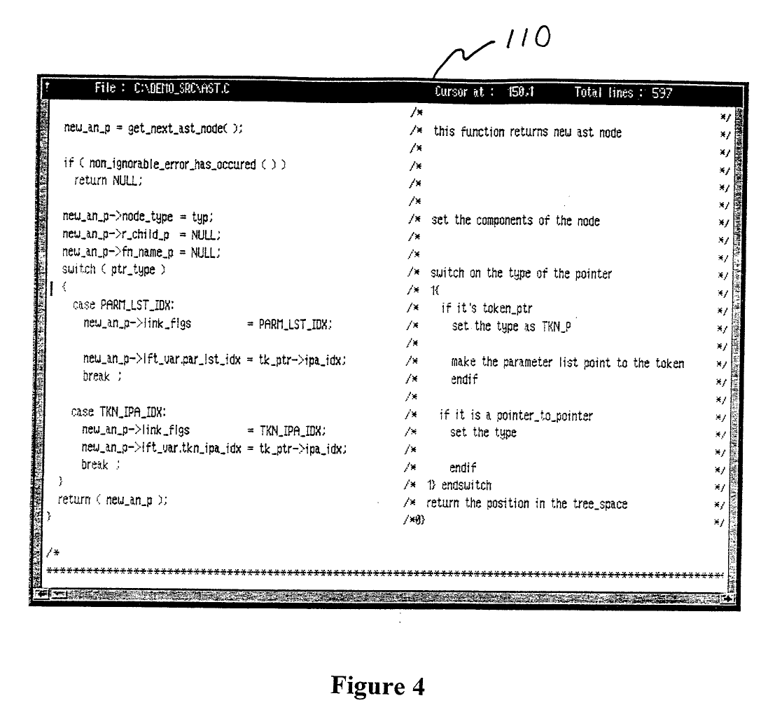

FIGS. 4-13 illustrate a sequence of screen images representing a working example of the present invention. The sequence will illustrate that, as certain touchkeys are selected, various groups are modified, and/or various keys within groups are modified depending on the context of the selection.

FIG. 4 illustrates example information displayed on an initial IDS screen 110. This is for the user's general reference.

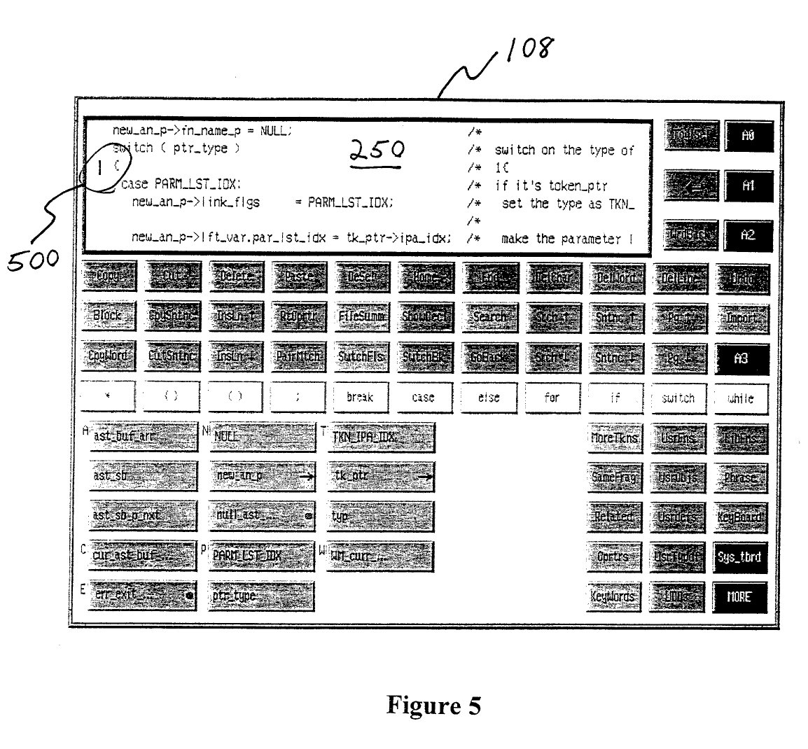

FIG. 5 illustrates an initial TS screen 108 for the example information illustrated in FIG. 4. The viewport (T-port) 250 in the initial TS screen 108 shows a smaller selected portion of this displayed information. The cursor 500 is located to the left of “{”.

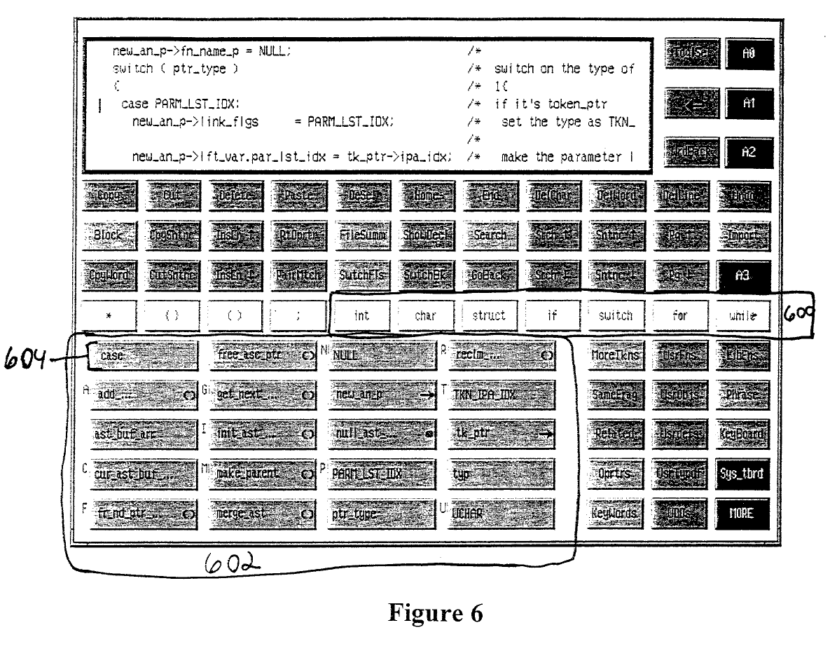

FIG. 6 illustrates that the cursor has been moved down to the next line. By comparing with the initial TS screen (FIG. 5) we can see that the cursor movement causes changes in both the operators/keywords group 600 and the probable identifiers group 602. Due to the context-sensitive prediction, even the keyword “case” 604 is displayed in the probable identifier group.

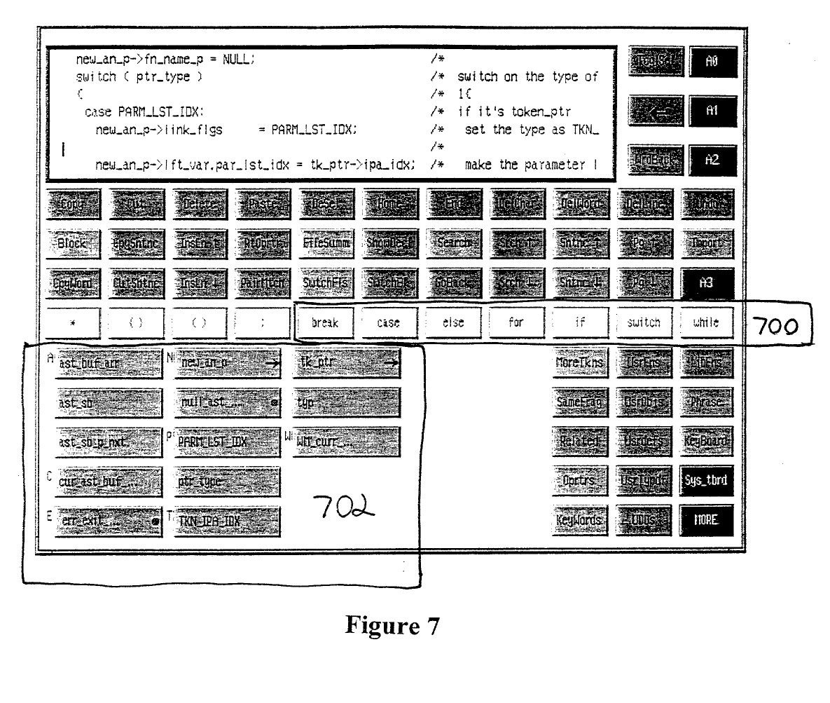

FIG. 7 illustrates that the cursor has been moved down again. Like before, the cursor movement causes changes in both the operators/keywords group 700 and the probable/identifiers group 702.

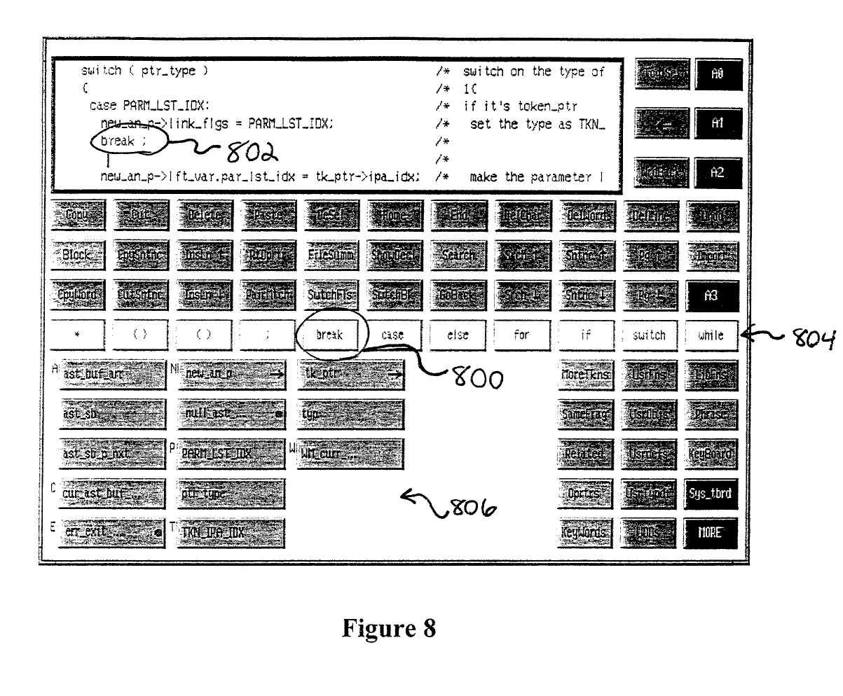

FIG. 8 illustrates that the touchkey “break” 800 has been touched. As a result, “break” 802 was inserted. However, the context remains essentially the same. Hence, neither the operators/keywords group 804 nor the probable identifiers group 806 changes.

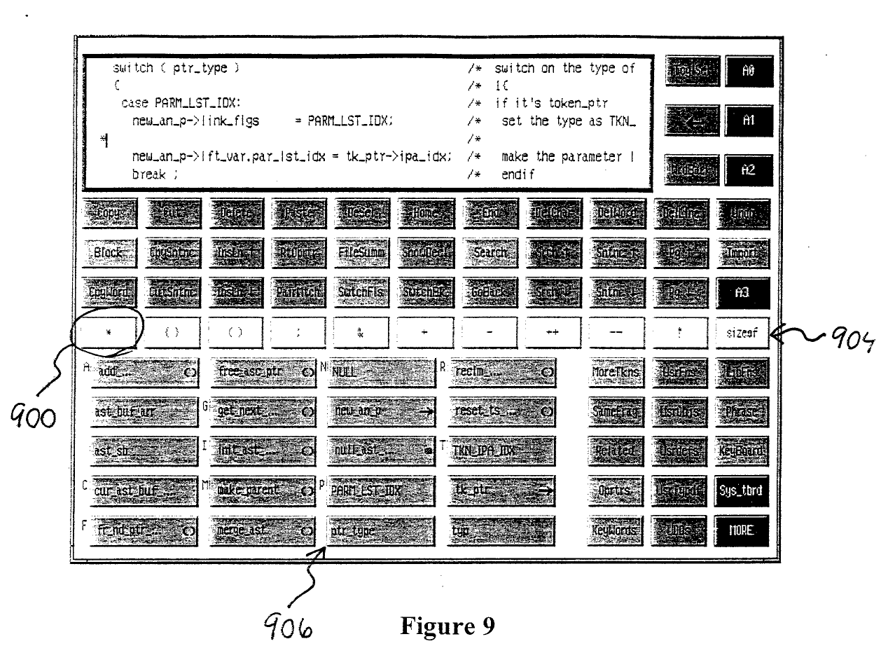

FIG. 9 illustrates that the touchkey “*” 900 in the operators/keywords was touched. It caused changes in both the operators/keywords group 902 and the probable identifiers group 904.

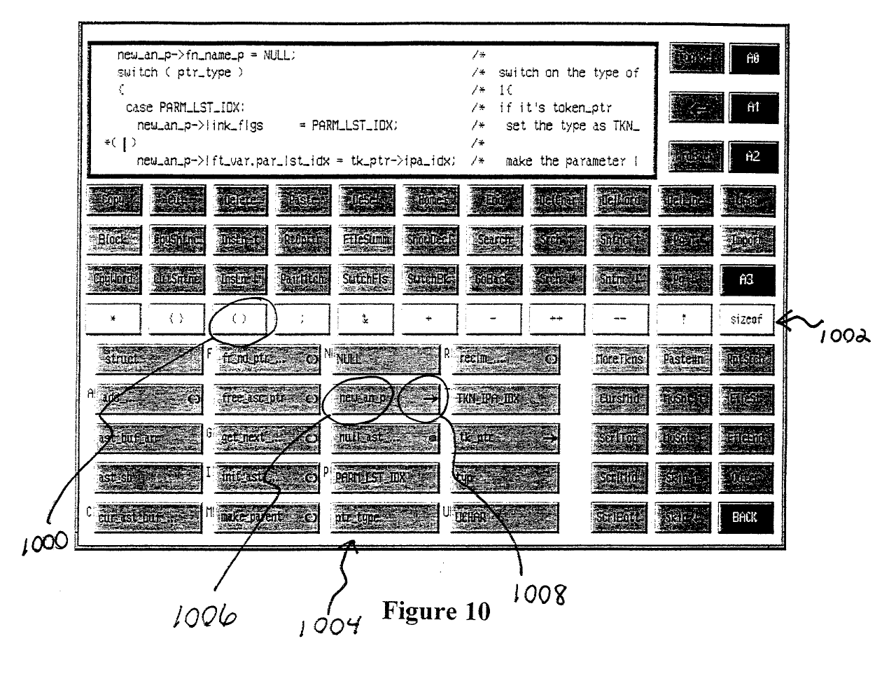

FIG. 10 illustrates that the touchkey “( )” 1000 in the operators/keywords was touched. The operators/keywords group 1002 remains unchanged, however, the probable identifiers group 1004 changes. This illustrates that a touch in one group changes the other group.

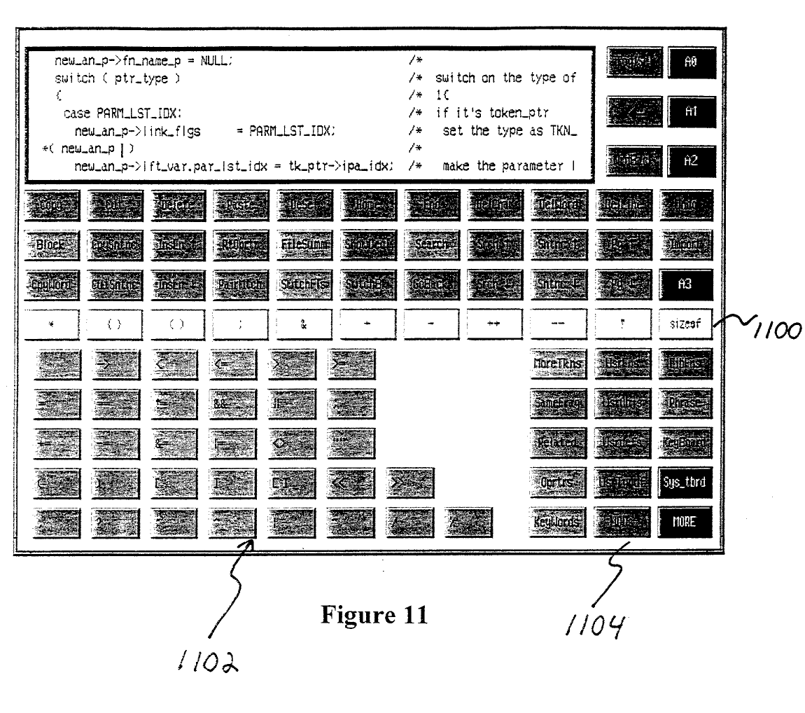

FIG. 11 illustrates that the touchkey “new_an_p→” from FIG. 10 1006 and 1008 is touched in its left part 1006 (in the probable identifiers group). The operators/keyword group 1100 remains unchanged. The contents of the probable identifiers groups 1102, however, are changed. This illustrates a very important element of one embodiment of the present invention—the ability to have split context sensitive touch input keys. A touch on one side of one touchkey in one group changes its own group but the other group remains unchanged.

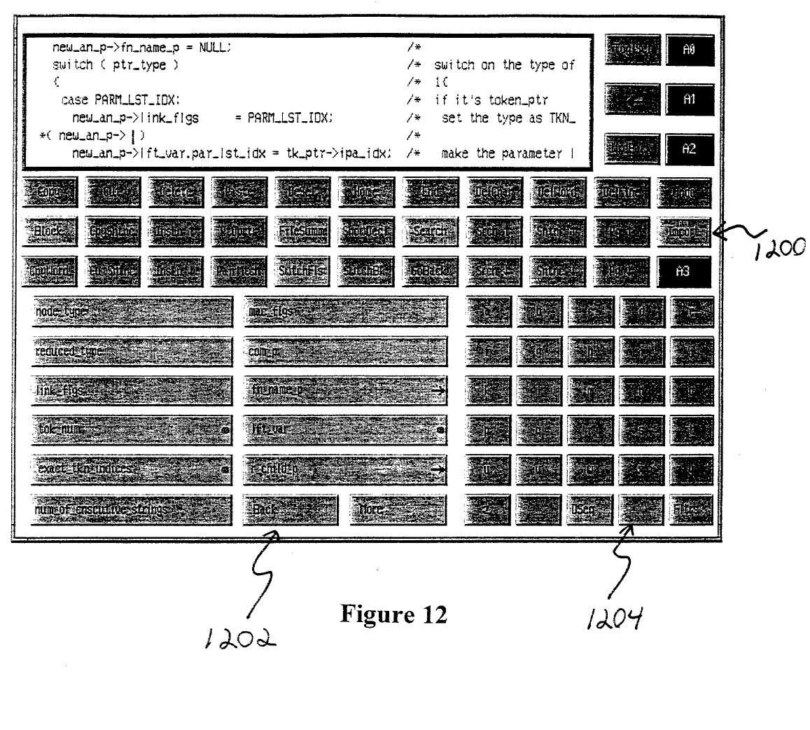

FIG. 12 illustrates that the touchkey “new_an_p→” from FIG. 10 1006 and 1008 is touched in its right part 1008 (in the probable identifiers group). The operators/keywords group 1100, the probable identifiers group 1102 and a third group 1104 are all replaced with new groups 1200, 1202 and 1204. This illustrates the concept of a touch in one group bringing in new groups.

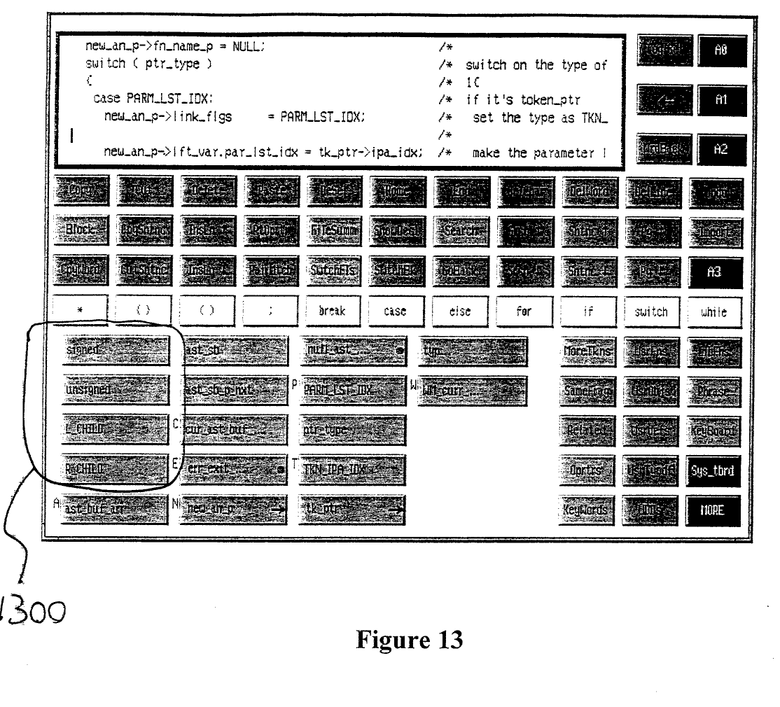

FIG. 13 illustrates an example of using prestored information assigned to a programmable touchkey. Specifically, the “Mem0” and “Mem1” touchkeys have assigned to them the keywords “signed” and “unsigned” which have been prestored in Mem0. The identifiers “L-CHILD” and “R-CHILD” have been stored in Mem1. The contents of Mem0 and Mem1 are then displayed in the beginning of the probable identifiers group 1300.

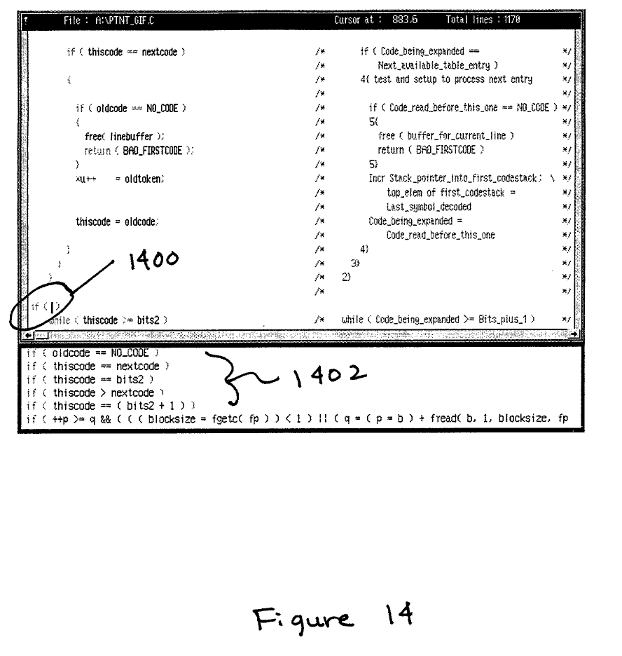

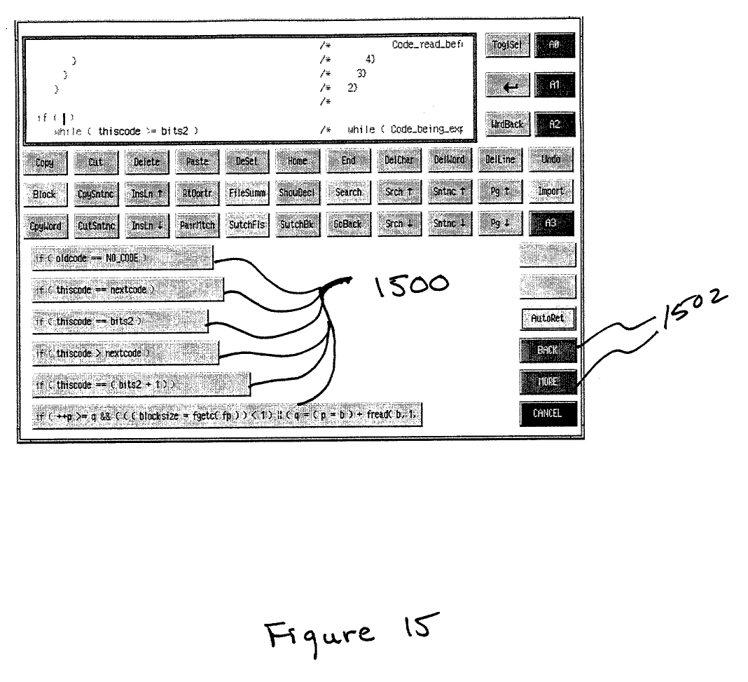

In addition to presenting short inputs as touch keys during the selection of possible inputs, the present invention converts phrases, both default and user defined, as possible touch keys. For example, FIG. 14 illustrates the information display screen after touching an “if” touch key. When a user selects the touch key “if” the system displays “if ( )” on the IDS and places the display cursor in the middle of the parentheses awaiting text entry. Possible choices, consisting of previously entered or default suggestions appear below the main IDS window in a separate window. If a user is interested in any of these phrases, they press the “phrase” touch key illustrated in group 262 in FIG. 2b. These phrases are then presented as touch screen entry buttons as shown in FIG. 15. Command keys 1502 allow a user to select “more” or return “back” to previously listed phrases.

As indicated earlier, an appendix is included with this specification that discusses all the settings of every option within the present inventive system. However, some noteworthy advantages of the present system are explicitly noted below. One advantage of a preferred embodiment of the present invention is the inclusion of customizable keys. A user sometimes has text which frequently, but sporadically, must be pasted within a file. In use, a block of text is selected and then stored in an unused customizable key. When that text is needed during editing, the user simply selects the now-defined key and the text is inserted at the current cursor position.

The present invention has been described in relation to inserting and editing source code files; however, editing comments and annotations to such files are also considered within its scope. During the editing of comments, the probable tokens displayed include phrases, as described above, based on the current command-line being commented and on phrases within earlier comments. One advantage of this functionality is that commenting is easier (thus more likely to be performed) and effectively forces a common commenting scheme on programmers within the environment.

### CONCLUSION

A system and method has been shown in the above embodiments for the effective implementation of dual-screen display and touch-entry of context sensitive buttons wherein the buttons displayed are those buttons which are predicted to be most needed by a user. While various preferred embodiments have been shown and described, it will be understood that there is no intent to limit the invention by such disclosure, but rather, it is intended to cover all modifications and alternate constructions falling within the spirit and scope of the invention as defined in the appended claims. For example, the present invention should not be limited by computer operating system, computer hardware platform, specific programming source language, or display hardware. In addition, the present invention can be implemented locally on a single PC, connected workstations (i.e. networked-LAN), across extended networks such as the Internet or using portable equipment such as laptop computers or wireless equipment (RF, microwaves, infrared, photonics, etc.).

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. An interactive touch screen programming system comprising:
a first touch entry screen;
a second display screen;
said first touch entry screen further comprising a plurality of dynamically changing touch entry buttons;
each of said dynamically changing touch entry buttons corresponding to at least one function;
said plurality of dynamically changing touch entry buttons segmented into a plurality of sets, said sets containing one or more of said dynamically changing touch entry buttons which perform a similar function, and wherein, based on a context of said programming system, said plurality of sets and all elements within each of said plurality of sets are updated to correspond to a most probable set of functions to be performed.

2. An interactive touch screen programming system, as per claim 1, wherein each of said sets correspond to one of file manipulation commands, editing commands, navigating commands, inserting code or comment phrases, inserting identifiers, inserting operators, inserting punctuation, inserting keywords, and changing a layout of said first touch entry screen.

3. An interactive touch screen programming system, as per claim 2, wherein said set corresponding to said changing a layout of said first touch entry screen comprises a touch entry button which, when selected, updates an original group of buttons within another of said plurality of sets to include a different group of buttons.

4. An interactive touch screen programming system, as per claim 3, wherein said different group of buttons are, in relation to said original group, a next most probable set of functions to be performed.

5. An interactive touch screen programming system, as per claim 1, wherein each of said plurality of sets is updated independently of updating of other of said plurality of sets.

6. An interactive touch screen programming system, as per claim 1, wherein at least one of said dynamically changing touch entry buttons corresponds to multiple functions.

7. An interactive touch screen programming system, as per claim 6, wherein said multiple functions are presented as physically separate button regions.

8. An interactive touch screen programming system, as per claim 6, wherein one function of said multiple functions is a base function and other functions of said multiple functions are likely alternatives to said base function.

9. An interactive touch screen programming system, as per claim 1, wherein said second display screen displays any of programming code, corresponding comments, flowcharts, and pseudo-code.

10. An interactive touch screen programming system, as per claim 9, wherein said context is dependent on a cursor position within a display on said second display screen.

11. An interactive touch screen programming system, as per claim 9, wherein said context is dependent on any of: a selected line of code within a display on said second display system and the present cursor position.

12. An interactive touch screen programming system, as per claim 1, wherein said context is dependent on alpha-numeric input received by said system.

13. An interactive touch screen programming system, as per claim 1, wherein said context is determined after every movement of a cursor.

14. An interactive touch screen programming system, as per claim 1, wherein said first touch entry screen further comprises a working window representing a portion of said second display screen.

15. An interactive touch screen programming system, as per claim 1, wherein said one or more components of said interactive touch screen programming system are located any of: locally, remotely, across networks or across communication mediums.

16. An interactive touch screen programming system, as per claim 15, wherein said across networks or across communication mediums includes any of: the Internet, world wide web, cellular, wireless, satellite or optical communication systems.

17. A method of selecting a set of context-sensitive touch-entry buttons included in a plurality of functionally-separate groups in a dual-screen programming system comprising the steps:
displaying at least one source file on a first display screen;
detecting input to said system;
determining a context of said system;
identifying a first set of said plurality of functionally-separate groups, wherein said first set contains those groups which, based on said context, are most likely to be selected next;
identifying, for each group of said first set, a corresponding second set of touch-entry buttons, wherein said corresponding second set contains those buttons which, based on said context, are most likely to be selected next;
displaying each of said corresponding second sets on a touch-entry screen, and
repeating said steps upon receiving an additional input.

18. A method of selecting a set of context-sensitive touch-entry buttons to include in a plurality of functionally-separate groups in a dual-screen programming system, as per claim 7, comprising the additional steps:
determining if said additional input is a request to update one of said corresponding second sets;
if the previous step is true, then, for said one of said corresponding second sets, creating an updated set by identifying those buttons which, based on said context, are next most likely to be selected next, and
displaying said updated set, if created.

19. A computer product containing computer code for creating, displaying and organizing multiple input tokens for associated programming code and comments, said tokens comprising any of program tokens, identifiers, reserved words, operators, and comment phrases and displayable on one or more computer display units, said computer product comprising:
code for displaying said associated programming code and comments;
code for displaying said tokens;
code to dynamically change said tokens displayed based on any of: a selected line of code within said display of: said associated programming code and comments, and a present cursor position;
code for organizing said plurality of dynamically changing tokens into a plurality of segmented sets, said sets containing one or more of said dynamically changing tokens which perform a similar function, and
wherein, based on a context of said programming system, said plurality of sets and all elements within each of said plurality of sets are updated to correspond to a most probable set of functions to be performed.

20. A computer product containing computer code for creating, displaying and organizing multiple input tokens for associated programming code and comments, as per claim 19 , wherein said dynamically changing tokens are actuated by any of: a touch screen input, mouse input, stylus, and pointing device.

21. A computer product containing computer code for creating, displaying and organizing multiple input tokens for associated programming code and comments, as per claim 19 , wherein each of said sets correspond to one of file manipulation commands, editing commands, navigating commands, inserting code or comment phrases, inserting identifiers, inserting operators, inserting punctuation, inserting keywords, and changing a layout.

22. A computer product containing computer code for creating, displaying and organizing multiple input tokens for associated programming code and comments, as per claim 19 , wherein each of said plurality of sets is updated independently of updating of other of said plurality of sets.

23. A computer product containing computer code for creating, displaying and organizing multiple input tokens for associated programming code and comments, as per claim 19, wherein one or more components of said computer product are located any of: locally, remotely, across networks or across communication mediums.

24. A computer product containing computer code for creating, displaying and organizing multiple input tokens for associated programming code and comments, as per claim 23 , wherein said across networks or across communication mediums includes any of: the Internet, world wide web, cellular, wireless, satellite or optical communication systems.

25. An interactive touch screen programming system comprising:
a first display entry screen;
a second display screen displaying programming code and comments;
a system for creating, displaying and organizing multiple input tokens for said displayed programming code and comments, said tokens comprising any of program tokens, identifiers, reserved words, operators, and comment phrases and displayable on said first display entry screen;
a system to dynamically change said tokens displayed based on any of: a selected line of code within said display of said programming code and comments, and a present cursor position;
a system to organize said plurality of dynamically changing tokens into a plurality of segmented sets, said sets containing one or more of said dynamically changing tokens which perform a similar function, and
wherein, based on a context of said programming system, said plurality of sets and all elements within each of said plurality of sets are updated to correspond to a most probable set of functions to be performed.

26. An interactive touch screen programming system, as per claim 25, wherein said dynamically changing tokens are actuated by any of: a touch screen input, mouse input, stylus, and pointing device.

27. An interactive touch screen programming system, as per claim 25, wherein each of said sets correspond to one of file manipulation commands, editing commands, navigating commands, inserting code or comment phrases, inserting identifiers, inserting operators, inserting punctuation, inserting keywords, and changing a layout.

28. An interactive touch screen programming system, as per claim 25, wherein each of said plurality of sets is updated independently of updating of other of said plurality of sets.

29. An interactive touch screen programming system, as per claim 25 , wherein one or more components of said touch screen programming system are located any of: locally, remotely, across networks or across communication mediums.

30. An interactive touch screen programming system, as per claim 29 , wherein said across networks or across communication mediums includes any of: the Internet, world wide web, cellular, wireless, satellite or optical communication systems.

31. A computer based method for creating, displaying and organizing multiple input tokens for associated programming code and comments, said tokens comprising any of program tokens, identifiers, reserved words, operators, and comment phrases and displayable on one or more computer display units, said computer product comprising:
displaying said associated programming code and comments;
displaying said tokens, each of said tokens corresponding to at least one function;
dynamically changing said tokens displayed based on any of: a selected line of code within said display of said associated programming code and comments, and a present cursor position;
organizing said plurality of dynamically changing tokens into a plurality of segmented sets, said sets containing one or more of said dynamically changing tokens which perform a similar function, and
wherein, based on a context of said programming system, said plurality of sets and all elements within each of said plurality of sets are updated to correspond to a most probable set of functions to be performed.

32. A computer based method for creating, displaying and organizing multiple input tokens for associated programming code and comments, as per claim 31, wherein said dynamically changing tokens are actuated by any of: a touch screen input, mouse input, stylus, and pointing device.

33. A computer based method for creating, displaying and organizing multiple input tokens for associated programming code and comments, as per claim 31, wherein each of said sets correspond to one of file manipulation commands, editing commands, navigating commands, inserting code or comment phrases, inserting identifiers, inserting operators, inserting punctuation, inserting keywords, and changing a layout.

34. A computer based method for creating, displaying and organizing multiple input tokens for associated programming code and comments, as per claim 31, wherein each of said plurality of sets is updated independently of updating of other of said plurality of sets.

35. A computer based method for creating, displaying and organizing multiple input tokens for associated programming code and comments, as per claim 31, wherein one or more components of said computer based method are located any of: locally, remotely, across networks or across communication mediums.

36. An interactive touch screen programming system, as per claim 29 , wherein said across networks or across communication mediums includes any of: the Internet, world wide web, cellular, wireless, satellite or optical communication systems.
